(19) United States
(12) Patent Application Publication
(10) Pub. No.: US 2016/0075477 A1
(43) Pub. Date: Mar. 17, 2016

(54) Chilling and Infusion Insert for Beverage Container

(71) Applicant: Michael HALIOUA, Brooklyn, NY (US)

(72) Inventor: Michael HALIOUA, Brooklyn, NY (US)

(21) Appl. No.: 14/854,842

(22) Filed: Sep. 15, 2015

Related U.S. Application Data
(60) Provisional application No. 62/050,310, filed on Sep. 15, 2014.

(51) Int. Cl. B65D 25/04; B65D 81/18; A47J 31/44; B65D 25/40

(52) U.S. Cl. CPC B65D 25/04; B65D 25/40; B65D 81/18; A47J 31/446

(57) ABSTRACT

A combined chilling and infusing insert for use with a beverage container includes a compartment and is insertable within, and may also be releasably attachable to, the beverage container for simultaneously chilling a beverage contained in the container while infusing a flavoring substance into the beverage. The compartment includes at least two sections which are isolated from each other by a shared partition. A first section is bounded around the outer periphery of the compartment by a wall that is substantially impervious to liquid, such as water, and a second section is similarly bounded by a wall containing at least one opening, and preferably a plurality of openings such as slits to allow the beverage to be infused with material contained in the second section.

### CROSS-REFERENCE TO RELATED APPLICATION

This application claims benefit under 35 U.S.C. 119(e) to U.S. Provisional application Ser. No. 62/050,310, filed Sep. 15, 2014, the entirety of which is incorporated by reference herein.

### BACKGROUND OF THE INVENTION

1. Field of the Invention

The present invention is directed to beverage containers and beverage dispensers for containing and dispensing chilled beverages. More particularly, the present invention is directed to an insert which is detachably attachable to, or detachably insertable into, a container configured to hold a beverage, with the insert capable of receiving ice, or facilitating beforehand the production of ice, for cooling the beverage when the insert is placed in the beverage container. Most particularly, the insert includes a chamber or compartment for receiving an infusible substance and for causing the infusible substance to infuse the beverage when the insert is placed in the container and within the beverage.

2. Discussion of Related Art

Beverage containers with inserts are known. Such containers typically include a chilling compartment in the form of a removable insert, such as a tube having a detachable lid at one end. With the lid detached or opened, the compartment may be filled with water and, with the lid back in place or closed, the water is frozen to ice and then the compartment can be inserted into the container to chill a beverage. Alternatively, the chilling compartment can be simply filled with ice (pieces, cubes, etc.) and the compartment inserted into the container for chilling the beverage. The beverage container may be any size, such as a portable drinking container, or a larger size suitable for tabletop dispensing by including a spigot or faucet through a container wall. The chilling compartment is typically formed of a solid, impervious wall such that as the ice melts in the compartment—which occurs from heat transfer between the ice and the beverage—the beverage will not become diluted. In other words, the melted ice remains in the compartment so that the compartment can be easily removed, emptied, refilled with fresh ice, and then reinserted into the container.

The chilling compartment may also include an attachment/detachment mechanism for connecting the compartment to a mouth of the container such that the body portion of the compartment will extend into the beverage. Such mechanism may include threading disposed about the detachable lid which mates with like threading on the container; a snap-fit or friction fit engagement between the compartment and the container; or an enlarged lip at an end of the compartment or lid for supporting the end of the compartment at the mouth of the container while the remaining portion of the compartment extends into the container and beverage. Still other techniques are known for connecting the compartment to the container for chilling liquid held in the container.

The above-described beverage containers include a removable chilling compartment designed to prevent dilution of a beverage by the melting ice contained in the compartment. As a result, the compartment wall is solid and substantially impervious to the water. However, oftentimes an infused beverage is desired, such as by infusing water or other beverage (wine, lemonade, etc.), with fresh fruit or vegetables, e.g., lemon, strawberry, cucumber, etc. In such instance, it is desired to have the flavor of the fruit/vegetables infuse into the beverage while preventing sizeable particles from the fruit/vegetables from entering the beverage. This is accomplished by an infuser compartment which is typically in the form of a removable insert to a beverage container, with the insert having a permeable wall including a plurality of slits or other openings. The infuser compartment receives infusing ingredients (lemon slices, for example) and is placed through the mouth of the container such that the infuser openings are positioned in the beverage. To replace the ingredients, the infuser can be removed, emptied, refilled, and reinserted.

A drawback of the beverage containers discussed above is that if the infuser compartment is used for ice, dilution of the beverage will occur through the wall openings as the ice melts. On the other hand, if the infuser ingredients are disposed in the chilling compartment, infusion will not occur because of the impervious compartment wall. This drawback is overcome by the present invention discussed below.

### SUMMARY OF THE INVENTION

The present invention is directed to a combined chilling and infusing insert for use with a beverage container. The insert includes a compartment and is insertable within, and may also be releasably attachable to, the beverage container for simultaneously chilling a beverage contained in the container while infusing a flavoring substance into the beverage. The compartment includes at least two sections which are isolated from each other by a shared partition. A first section is bounded around the outer periphery of the compartment by a wall that is substantially impervious to liquid, such as water, and a second section is similarly bounded by a wall containing at least one opening, and preferably a plurality of openings such as slits, to allow the beverage to be infused with material contained in the second section. When the first section contains ice, and the second section contains an infusible substance, such as sliced lemons, etc., and then the insert is disposed in the beverage container, the beverage in the container will be simultaneously cooled from the ice in the first section without causing dilution of the beverage as the ice melts, and the beverage will be infused by the lemons through the opening(s) in the second section.

In accordance with one aspect of the invention, an insert for use in a beverage container containing a beverage includes: a bottom member having an inside surface, an outside surface and a continuous edge; a continuous side wall having an inside surface and an outside surface is connected to the continuous edge of the bottom member at a first end. The side wall has a second end distally disposed from the first end. The second end forms a mouth such that a chamber is defined between the inside surface of the bottom member and the inside surface of the side wall. The continuous side wall has a first region and a second region. The insert further has a divider wall connected to the inside surface of the bottom member and extending towards the mouth. The divider wall separates a first portion of the chamber bounded by the first region of the continuous side wall and the bottom member from a second portion of the chamber bounded by the second region of the continuous side wall and the bottom member. The bottom member in the second portion of the chamber is solid. The first region of the continuous side wall has an opening extending between the inside surface and the outside surface of the continuous side wall for allowing fluid in the first portion of the chamber to flow through the opening in the first region of the continuous side wall, while the second region of the continuous side wall prevents communication of fluid from the second portion of the chamber through the second region of the continuous side wall. When material is disposed in the first portion of the chamber, such as a flavor infusing material, e.g., lemons, by way of non-limiting example, and the insert is immersed in the beverage, the beverage will communicate with the material through the first region of the continuous side wall but will not communicate with the material through the second region of the continuous side wall or the bottom member in the second portion of the chamber.

In another aspect, the material disposed in the first portion of the chamber is a flavor infusing material.

In another aspect, the second portion of the chamber is configured to accept a second material, wherein when the second material is disposed in the second portion of the chamber, and the insert is immersed in the beverage, the beverage will be prevented from communicating with the second material through the second region of the continuous side wall and will not communicate with the second material through the first region of the continuous side wall.

In another aspect, the second material is a cooling material, such as, by way of non-limiting example, ice.

In another aspect, the insert, in the region of the mouth, has an attachment/detachment mechanism configured to detachably attach the insert to an engagement portion of the container or to a standalone cap for sealing the mouth of the insert.

In another aspect, the attachment/detachment mechanism is one selected from the group consisting of a threading, a snap-fit mechanism and a friction fit engagement mechanism.

In another aspect, the insert is of unitary construction.

In another aspect, the insert is made of one selected from the group consisting of food-storage grade plastic and food-storage grade metal.

In another aspect, the opening in the first region of the continuous side wall comprises a plurality of openings.

In another aspect, the plurality of openings are configured as slits of the same size.

In another aspect, the plurality of openings have respective different sizes.

In another aspect, the plurality of openings are holes.

In another aspect, the holes are all of the same size.

In another aspect, at least some of the holes have respective different sizes.

In another aspect, the top of the insert has a flange which is dimensioned for seating at a mouth of the container in which the insert is disposed.

In another aspect, the bottom member has holes/slits on the side of the first portion of the chamber but is solid on the side of the second portion of the chamber.

In accordance with another aspect of the invention a combination beverage container and insert includes: a beverage container having: a container body configured to hold a beverage, the container body having an opening through which the container is fillable with a beverage; and a container cap configured to detachably seal the opening of the container body; and an insert configured to be detachably attachable to the beverage container, the insert having: a bottom member having an inside surface, an outside surface and a continuous edge; a continuous side wall having an inside surface and an outside surface is connected to the continuous edge of the bottom member at a first end. The side wall has a second end distally disposed from the first end. The second end forms a mouth such that a chamber is defined between the inside surface of the bottom member and the inside surface of the side wall. The continuous side wall has a first region and a second region. The insert further has a divider wall connected to the inside surface of the bottom member and extending towards the mouth. The divider wall separates a first portion of the chamber bounded by the first region of the continuous side wall and the bottom member from a second portion of the chamber bounded by the second region of the continuous side wall and the bottom member. The bottom member in the second portion of the chamber is solid. The first region of the continuous side wall has an opening extending between the inside surface and the outside surface of the continuous side wall for allowing fluid in the first portion of the chamber to flow through the opening in the first region of the continuous side wall, while the second region of the continuous side wall prevents communication of fluid from the second portion of the chamber through the second region of the continuous side wall. When material is disposed in the first portion of the chamber, such as a flavor infusing material, e.g., lemons, by way of non-limiting example, and the insert is immersed in the beverage, the beverage will communicate with the material through the first region of the continuous side wall but will not communicate with the material through the second region of the continuous side wall or the bottom member in the second portion of the chamber.

In another aspect, the material disposed in the first portion of the chamber is a flavor infusing material.

In another aspect, the second portion of the chamber is configured to accept a second material, wherein when the second material is disposed in the second portion of the chamber, and the insert is immersed in the beverage, the beverage will be prevented from communicating with the second material through the second region of the continuous side wall and will not communicate with the second material through the first region of the continuous side wall.

In another aspect, the second material is a cooling material.

In another aspect, the insert, in the region of the mouth, has an attachment/detachment mechanism configured to detachably attach the insert to an engagement portion of the container.

In another aspect, the attachment/detachment mechanism is one selected from the group consisting of a threading, a snap-fit mechanism and a friction fit engagement mechanism.

In another aspect, the insert is made of one selected from the group consisting of food-storage grade plastic and food-storage grade metal.

In another aspect, the opening in the first region of the continuous side wall comprises a plurality of openings.

In another aspect, the top of the insert has a flange which is dimensioned for seating at a mouth of the container in which the insert is disposed.

In another aspect, the bottom member has holes/slits on the side of the first portion of the chamber but is solid on the side of the second portion of the chamber.

In another aspect, the container opening is used to remove beverage from the container.

In another aspect, the container further comprises a spigot configured to remove beverage from the container.

### BRIEF DESCRIPTION OF THE DRAWINGS

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein. In the drawings:

FIG. 1 shows a side view of an insert in accordance with an embodiment, with the insert shown oriented along a compartment dividing wall;

FIG. 2 shows the insert oriented along an infusion side;

FIG. 3 shows a perspective view of the insert;

FIG. 4 shows an end view of the insert in a direction of the top to the bottom;

FIG. 5 shows the insert oriented along a chilling side; and

FIG. 6 shows the insert arranged in a beverage container.

### DETAILED DESCRIPTION OF THE PRESENTLY PREFERRED EMBODIMENTS

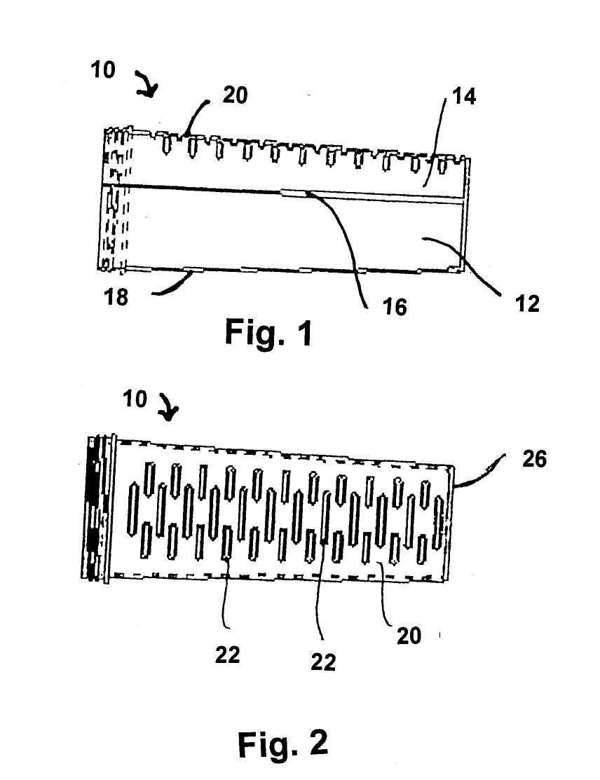

An insert 10 in accordance with an embodiment of the invention will now be described making reference to FIGS. 1-5. As can be seen particularly in FIG. 1, the insert is divided into a first section 12 and a second section 14. The first and second sections are chambers within the insert 10. As can be seen from, for example, FIG. 1, in a preferred embodiment, the two chambers of the insert 10 extend substantially parallel to one another over substantially the entire longitudinal extent of the insert 10.

The sections 12, 14 can be equally sized or, preferably and as shown in FIG. 1, the second section 14 can be smaller, in volume, than the first section 12. That is, while the respective lengths of sections 12, 14 are preferably equal, the volumes of the first section 12 would typically be smaller than that of the second section.

The insert 10 further includes a dividing wall or partition 16 for dividing the sections 12, 14 from each other. The dividing wall 16 is preferably configured as a solid wall such that contents in the first section 12 will not enter the second section 14, and vice versa.

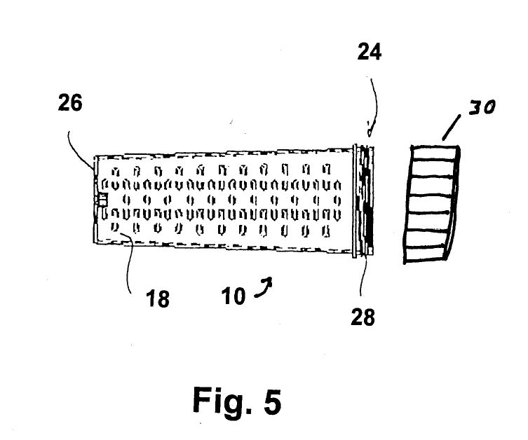

The first section 12 has a solid outer wall 18, and the second section has a vented outer wall 20 having one or more openings, such as slits 22 formed therein. The insert 10 further includes a bottom wall 26 and a top 24. The top 24 forms a mouth and includes an engagement mechanism, such as threading or the like for allowing the releasable attachment of a cap, for example a cap of a sports bottle or other container for liquid, thereto for closing the top 24 and thereby sealing any contents contained in the first and second sections 12, 14. Alternatively, a separate cap 30, as shown in FIG. 5, may be used such that a sealed insert 10 is provided by engaging the cap 30 with the top 24 of the insert 10, in any of the ways discussed above. If a standalone cap is used, the insert 10 can simply, for example, be dropped into the beverage, and can therefore be used in containers that do not have engagement mechanisms compatible with the insert 10.

Preferably, to have the first section 12 have a larger volume than the second section 14, the dividing wall 16 is arranged to extend closer, along its entire length, to the vented outer wall 20 than to the solid outer wall 18.

The insert 10 is bounded at one end, i.e., the end of the insert 10 opposite the top 24, by the bottom wall 26, seen most clearly in FIG. 5. The bottom wall 26, the solid outer wall 18, the vented outer wall 20, and the solid dividing wall 16 are arranged with respect to one another such that the chamber of the first section 12 is delimited, at least in part, by the solid outer wall 18, the solid dividing wall 16, and a portion of the bottom wall 26 closest to the solid outer wall 18, i.e., a portion of bottom wall 26 to one side of the solid dividing wall 16. By this arrangement, the chamber of the second section 14 is delimited, at least in part by the vented outer wall 20, the solid dividing wall 16, and a portion of the bottom wall 26 closest to the vented outer wall 20, i.e., a portion of the bottom wall to the other side of the solid dividing wall 16. It should be noted that while the bottom wall may be solid throughout, it can also be solid only under the first section 12, while being vented, i.e., permeable, in the portion of the bottom wall 26 that delimits the chamber of the second section 14.

This arrangement of components results in two substantially parallel chambers, corresponding to the first and second sections 12 and 14, respectively, being formed in the insert 10, with each chamber extending along the longitudinal extent of the insert 10.

Except for the cap, the insert 10 is preferably unitarily formed as a single piece item and manufactured from a plastic material using injection molding techniques. The plastic material is of the type suitable for food storage and consumption and may be opaque, translucent or transparent. Alternatively, the insert can be formed of a metal suitable for food storage and consumption, such as stainless steel or aluminum.

In use, the first section 12, which is referred to as a chilling section, will be partially or fully filled with ice pieces. The second section 14, which is referred to as an infusing section, will be partially or fully filled with an infusing substance, such as one or more fruits or vegetables.

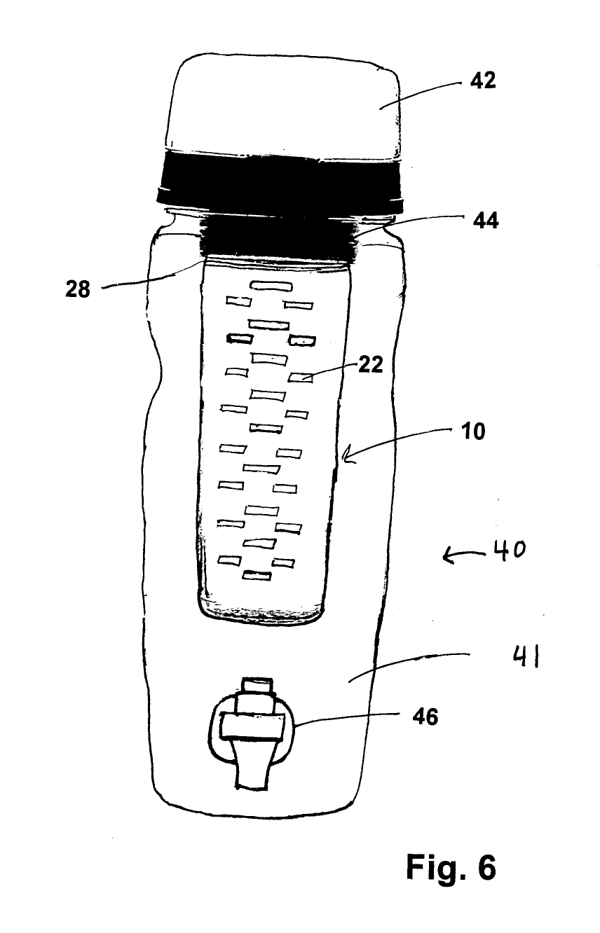

Once filled, a cap can be attached to the top 24, such as by friction fit, snap fit, threading, or any other manner, to close the mouth of the insert and, thereafter, the insert is placed into a beverage container, such as a dispenser or container which contains a beverage, e.g., lemonade, etc. As will be discussed below with reference to FIG. 6, the cap can be the cap of a beverage container, such as a sports bottle.

After a time of the insert being positioned in the beverage, the ice in the first section will chill the beverage via thermal transfer, i.e., conduction, through the solid wall 18, whereas the infusing substance (e.g., lemons, etc.) will infuse flavor into the beverage via the beverage being permitted to permeate the slits 22 and contact the infusing substance and then exit again having been infused with the flavor of the infusing substance.

Notably, as the ice melts in the first section 12, the resulting melt water will remain in the first section 12, and not dilute the beverage because the first section 12 containing the ice, and whatever melt may be in the first section 12, is bounded by the external solid wall 18, a portion of the solid bottom wall 26, and the solid, shared partition 16.

To replenish the insert with additional ice and/or new diffusing material, the insert 10 need simply be removed from the container, emptied, and refilled. Thereafter, the insert can, again, be disposed within the beverage container. Alternatively, water can be placed into the first section 12 ahead of time and the insert 10 placed in the freezer to create a solid block of ice in the first section 12. In this case, it is preferable for the first section 12 to include a fill line to account for the expansion of freezing water, to prevent a bursting of the insert 10 during freezing.

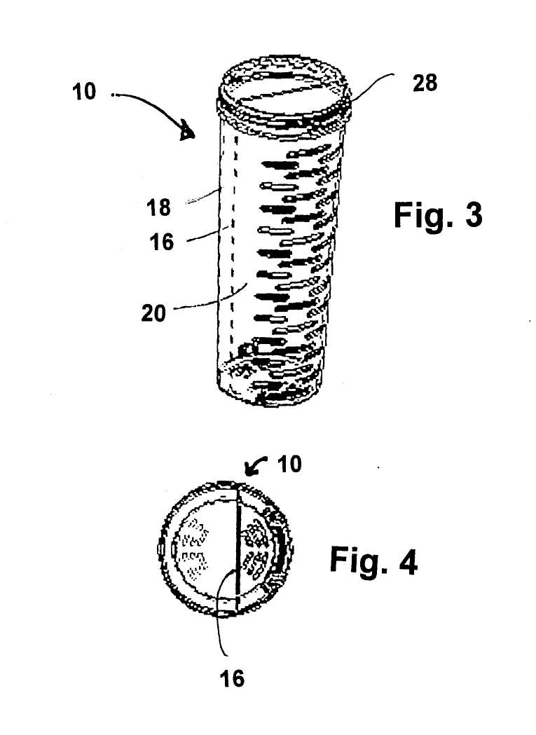

In a preferred embodiment, the threading 28, seen most clearly in FIGS. 3 and 5, disposed about the mouth 24 may engage a cap, and/or threading on the cap may engage a mouth of the beverage container in which the insert 10 is mounted in order to fixedly position the insert in the container. In this manner, the top 24 of the insert is easily accessible through the mouth of the container. This provides for filling/refilling the insert without the need to first remove the insert from the container. When not in use, however, the insert can be removed for cleaning, storage and so on.

As an alternative to threading being used to affix the insert to the container, other releasable techniques/configurations may be employed, such as by way of example, snap fit, friction fit, press fit, etc.

Also, although the vented wall 20 is shown having a plurality of narrow slits 22 arranged in a particular pattern with some slits being longer than others, any arrangement can be provided so long as the openings function in their intended manner, namely, to allow infusion of a beverage by exposing the beverage to substance contained in the second section. For example, other than slits, different configured openings can be used such as holes arranged in any manner through the vented wall 20. Moreover, although it is preferred that the slits or other openings are dimensioned to be small such that larger particles of the diffusing material will be prevented from entering the beverage, such is a design choice. In other words, larger slits may be provided if such particles are desired.

In one embodiment, the insert 10 will be used along with a beverage dispenser of the type having a faucet or spigot disposed in an outer wall of the dispenser for dispensing infused and chilled beverages as a result of the disposition if the insert in the dispenser. In this manner, a beverage contained in the dispenser can be simultaneously chilled and infused.

FIG. 6 shows an embodiment with a combination beverage container and insert 10. In this embodiment the insert 10 is detachably installed inside of a beverage container 40. While inside the beverage container the insert 10 performs in exactly the same manner described above in the description making reference to FIGS. 1-5.

In this embodiment, the beverage container 40 has a body portion 41 and a cap 42 to seal the top opening through which both the beverage and the insert 10 will be put into the beverage container 40. In one embodiment, the cap 42 has an attachment mechanism 44 that is configured to engage with structure at the top of the insert 10, such as the threading 28. The threading 28, seen most clearly in FIGS. 3 and 5, is disposed about the mouth 24 may engage a cap, and/or threading on the cap may engage a mouth of the beverage container in which the insert 10 is mounted in order to fixedly position the insert in the container. In this manner, the top 24 of the insert is easily accessible through the mouth of the container. This provides for filling/refilling the insert without the need to first remove the insert from the container. When not in use, however, the insert can be removed for cleaning, storage and so on.

As an alternative to threading being used to affix the insert to the container 40, other releasable techniques/configurations may be employed, such as by way of example, snap fit, friction fit, press fit, etc. As can be seen in FIG. 6, the beverage container 40, in one embodiment, has a spigot 46 in the body 41, which permits pouring of the beverage without opening the cap. However, while FIG. 6 shows the spigot 46, is invention is not limited to a container with a spigot. As would be understood, the beverage container can be configured without the spigot so as to function, e.g., as a sports bottle, in which the user, in addition to filling the container from the top, also can drink from the top of the container, by either removing the cap, or by a mechanism associated with the cap that permits sipping or other drinking through the cap, without removing the cap.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An insert for use in a beverage container containing a beverage, the insert comprising:
a bottom member having an inside surface, an outside surface and a continuous edge;
a continuous side wall having an inside surface and an outside surface and connected to the continuous edge of the bottom member at a first end, the side wall having a second end distally disposed from the first end, the second end forming a mouth such that a chamber is defined between the inside surface of the bottom member and the inside surface of the side wall, the continuous side wall having a first region and a second region;
a divider wall connected to the inside surface of the bottom member and extending towards the mouth, the divider wall separating a first portion of the chamber bounded by the first region of the continuous side wall and the bottom member from a second portion of the chamber bounded by the second region of the continuous side wall and the bottom member, wherein the bottom member in the second portion of the chamber is solid;
the first region of the continuous side wall having an opening extending between the inside surface and the outside surface of the continuous side wall for allowing fluid in the first portion of the chamber to flow through the opening in the first region of the continuous side wall;
the second region of the continuous side wall preventing communication of fluid from the second portion of the chamber through the second region of the continuous side wall;
wherein when material is disposed in the first portion of the chamber, and the insert is immersed in the beverage, the beverage will communicate with the material through the first region of the continuous side wall but will not communicate with the material through the second region of the continuous side wall or the bottom member in the second portion of the chamber.

2. The insert according to claim 1, wherein the material disposed in the first portion of the chamber is a flavor infusing material.

3. The insert according to claim 2, wherein the second portion of the chamber is configured to accept a second material, wherein when the second material is disposed in the second portion of the chamber, and the insert is immersed in the beverage, the beverage will be prevented from communicating with the second material through the second region of the continuous side wall and will not communicate with the second material through the first region of the continuous side wall.

4. The insert according to claim 3, wherein the second material is a cooling material.

5. The insert according to claim 1, wherein the insert, in the region of the mouth, has an attachment/detachment mechanism configured to detachably attach the insert to an engagement portion of the container, or to a standalone cap for sealing the mouth of the insert.

6. The insert according to claim 5, wherein the attachment/detachment mechanism is one selected from the group consisting of a threading, a snap-fit mechanism and a friction fit engagement mechanism.

7. The insert according to claim 1, wherein the insert is of unitary construction.

8. The insert according to claim 1, wherein the insert is made of one selected from the group consisting of food-storage grade plastic and food-storage grade metal.

9. The insert according to claim 1, wherein the opening in the first region of the continuous side wall comprises a plurality of openings.

10. The insert according to claim 9, wherein the plurality of openings are configured as slits of the same size.

11. The insert according to claim 9, wherein the plurality of openings have respective different sizes.

12. The insert according to claim 9, wherein the plurality of openings are holes.

13. The insert according to claim 12, wherein the holes are all of the same size.

14. The insert according to claim 12, wherein at least some of the holes have respective different sizes.

15. The insert according to claim 1, wherein the top of the insert has a flange which is dimensioned for seating at a mouth of the container in which the insert is disposed.

16. The insert according to claim 1, wherein the bottom member has holes/slits on the side of the first portion of the chamber but is solid on the side of the second portion of the chamber.

17. A combination beverage container and insert, comprising:
a beverage container having:
a container body configured to hold a beverage, the container body having an opening through which the container is fillable with a beverage; and
a container cap configured to detachably seal the opening of the container body; and
an insert configured to be detachably attachable to the beverage container, the insert having:
a bottom member having an inside surface, an outside surface and a continuous edge;
a continuous side wall having an inside surface and an outside surface and connected to the continuous edge of the bottom member at a first end, the side wall having a second end distally disposed from the first end, the second end forming a mouth such that a chamber is defined between the inside surface of the bottom member and the inside surface of the side wall, the continuous side wall having a first region and a second region;
a divider wall connected to the inside surface of the bottom member and extending towards the mouth, the divider wall separating a first portion of the chamber bounded by the first region of the continuous side wall and the bottom member from a second portion of the chamber bounded by the second region of the continuous side wall and the bottom member, wherein the bottom member in the second portion of the chamber is solid;
the first region of the continuous side wall having an opening extending between the inside surface and the outside surface of the continuous side wall for allowing fluid in the first portion of the chamber to flow through the opening in the first region of the continuous side wall;
the second region of the continuous side wall preventing communication of fluid from the second portion of the chamber through the second region of the continuous side wall;
wherein when material is disposed in the first portion of the chamber, and the insert is immersed in the beverage, the beverage will communicate with the material through the first region of the continuous side wall but will not communicate with the material through the second region of the continuous side wall or the bottom member in the second portion of the chamber.

18. The combination beverage container and insert according claim 17, wherein the material disposed in the first portion of the chamber is a flavor infusing material.

19. The combination beverage container and insert according claim 18, wherein the second portion of the chamber is configured to accept a second material, wherein when the second material is disposed in the second portion of the chamber, and the insert is immersed in the beverage, the beverage will be prevented from communicating with the second material through the second region of the continuous side wall and will not communicate with the second material through the first region of the continuous side wall.

20. The combination beverage container and insert according claim 19, wherein the second material is a cooling material.

21. The combination beverage container and insert according claim 17, wherein the insert, in the region of the mouth, has an attachment/detachment mechanism configured to detachably attach the insert to an engagement portion of the container.

22. The combination beverage container and insert according claim 21, wherein the attachment/detachment mechanism is one selected from the group consisting of a threading, a snap-fit mechanism and a friction fit engagement mechanism.

23. The combination beverage container and insert according claim 17, wherein the insert is made of one selected from the group consisting of food-storage grade plastic and food-storage grade metal.

24. The combination beverage container and insert according claim 17, wherein the opening in the first region of the continuous side wall comprises a plurality of openings.

25. The combination beverage container and insert according claim 17, wherein the top of the insert has a flange which is dimensioned for seating at a mouth of the container in which the insert is disposed.

26. The combination beverage container and insert according claim 17, wherein the bottom member has holes/slits on the side of the first portion of the chamber but is solid on the side of the second portion of the chamber.

27. The combination beverage container and insert according claim 17, wherein the container opening is used to remove beverage from the container.

28. The combination beverage container and insert according claim 17, wherein the container further comprises a spigot configured to remove beverage from the container.
